(19) United States
(12) Patent Application Publication
(10) Pub. No.: US 2018/0294483 A1
(43) Pub. Date: Oct. 11, 2018

(54) POSITIVE ELECTRODE PLATE AND ENERGY STORAGE DEVICE

(71) Applicant: CONTEMPORARY AMPEREX TECHNOLOGY CO., LIMITED, Ningde (CN)

(72) Inventors: Ming Zhang, Ningde (CN); Changlong Han, Ningde (CN)

(21) Appl. No.: 15/942,178

(22) Filed: Mar. 30, 2018

(30) Foreign Application Priority Data
Apr. 7, 2017 (CN) 201710224328.5

(51) Int. Cl. H01M 4/62; H01M 4/525; H01M 4/505; H01M 10/0525

(52) U.S. Cl. CPC H01M 4/628; H01M 4/525; H01M 4/505; H01M 2004/028; H01M 4/625; H01M 10/0525; H01M 4/623

(57) ABSTRACT

The present disclosure provides a positive electrode plate and an energy storage device. The positive electrode plate comprises a positive current collector and a positive electrode film provided on the positive current collector and comprising a positive electrode active material; the positive electrode film further comprises an additive, the additive comprises a C—C double bond-containing sultone. When the positive electrode plate of the present disclosure is applied in the energy storage device, the energy storage device has lower direct current internal resistance, excellent high temperature storage performance, excellent high temperature thermal stability performance and excellent low temperature lithium precipitation performance at the same time.

### CROSS-REFERENCE TO RELATED APPLICATIONS

The present application claims priority to Chinese patent application No. CN201710224328.5, filed on Apr. 7, 2017, which is incorporated herein by reference in its entirety.

### FIELD OF THE PRESENT DISCLOSURE

The present disclosure relates to the field of energy storage device, and more specifically relates to a positive electrode plate and an energy storage device.

### BACKGROUND OF THE PRESENT DISCLOSURE

A lithium-ion battery has a widely application prospect in fields of consumer electronics, electric vehicle battery, energy storage power and the like due to its advantages, such as high energy density, long cycle life, non-pollution and the like.

No matter in which application field the lithium-ion battery is applied, people present higher requirements on endurance mileage, stability performance and safety performance of the lithium-ion battery. In order to improve energy density of the lithium-ion battery, developing a positive electrode active material with high specific capacity is one of effective ways. At present, nickel-rich positive electrode active material has become a research hotpot due to its high theoretical specific capacity compared to other positive electrode active materials. However, the nickel-rich positive electrode active material has a strong oxidizing property due to a high content of nickel metal, which may easily lead to the occurrence of an electrochemical oxidizing reaction of an electrolyte on the surface of nickel-rich positive electrode active material, and cause the structure of nickel-rich positive electrode active material to change at the same time, thereby causing the transition metal (such as nickel, cobalt) to dissolve out due to the occurrence of an reduction reaction. As a result, the electrochemical performance of the lithium-ion battery would be deteriorated, especially for high temperature storage performance, moreover high temperature thermal stable performance of the lithium-ion battery would also be deteriorated.

Therefore, effectively inhibiting the oxidizing and decomposition of the electrolyte caused by the nickel-rich positive electrode active material is a key to improve high temperature storage performance of the lithium-ion battery. In the lithium-ion battery, 1,3-propene sultone (PST) is commonly used as an electrolyte additive to improve the high temperature storage performance of the lithium-ion battery. However, PST as the electrolyte additive is easily reduced on a surface of a negative electrode film of the lithium-ion battery to form a SEI membrane with a high resistance, thereby significantly deteriorating power performance of the lithium-ion battery.

Therefore, it is urgently need to provide a new technology so as to make the lithium-ion battery have excellent high temperature storage performance, excellent low temperature direct current internal resistance, excellent low temperature lithium precipitation performance and excellent high temperature thermal stability performance at the same time.

### SUMMARY OF THE PRESENT DISCLOSURE

In view of the problems existing in the background, an object of the present disclosure is to provide a positive electrode plate and an energy storage device, the positive electrode plate has good interface stability performance, when the positive electrode plate is applied in the energy storage device, interface resistance of the negative electrode plate of the energy storage device will not be significantly increased, so as to make the energy storage device have lower direct current internal resistance, and make the energy storage device have excellent high temperature storage performance, excellent high temperature thermal stability performance and excellent low temperature lithium precipitation performance at the same time.

In order to achieve the above objects, in a first aspect of the present disclosure, the present disclosure provides a positive electrode plate, which comprises: a positive current collector and a positive electrode film provided on the positive current collector and comprising a positive electrode active material; the positive electrode film further comprises an additive, the additive comprises a C—C double bond-containing sultone.

In a second aspect of the present disclosure, the present disclosure provides an energy storage device, which comprises the positive electrode plate according to the first aspect of the present disclosure.

Compared to the common technologies, the present disclosure has the following beneficial effects: the positive electrode plate of the present disclosure has good interface stability performance, when the positive electrode plate is applied in the energy storage device, interface resistance of the negative electrode plate of the energy storage device will not be significantly increased, so as to make the energy storage device have lower direct current internal resistance, and make the energy storage device have excellent high temperature storage performance, excellent high temperature thermal stability performance and excellent low temperature lithium precipitation performance at the same time. Preparation method of the positive electrode plate of the present disclosure is simple in process, easy to operate and suitable for large scale production.

### DETAILED DESCRIPTION

Hereinafter a positive electrode plate and an energy storage device according to the present disclosure are described in detail.

Firstly, a positive electrode plate according to a first aspect of the present disclosure is described.

The positive electrode plate according to the first aspect the present disclosure comprises a positive current collector and a positive electrode film. The positive electrode film is provided on the positive current collector. The positive electrode film comprises a positive electrode active material. The positive electrode film further comprises an additive. The additive comprises a C—C double bond-containing sultone.

In the positive electrode plate according to the first aspect of the present disclosure, oxidizing polymerization reaction of the C—C double bond-containing sultone will occur on a surface of the positive electrode plate of the energy storage device, so as to form a dense passivation film on the surface of the positive electrode plate, the passivation film can effectively prevent the occurrence of oxidizing and decomposition of the electrolyte on the surface of the positive electrode plate, which can improve anti-oxidation capability of the positive electrode plate, so as to make the positive electrode plate have good interface stability performance; meanwhile the C—C double bond-containing sultone as the additive added into the positive electrode plate can also prevent the C—C double bond-containing sultone from reducing and forming a SEI membrane with a high resistance on the surface of the negative electrode plate, thereby overcoming adverse effect on resistance of negative electrode interface when the C—C double bond-containing sultone is added into the electrolyte; furthermore, due to the C—C double bond, the C—C double bond-containing sultone has high boiling point, therefore the C—C double bond-containing sultone will not volatilize under high temperature drying when the C—C double bond-containing sultone as the additive is added into a positive electrode slurry for forming the positive electrode plate, so the C—C double bond-containing sultone can play its full role in improving performances of the energy storage device.

In the positive electrode plate according to the first aspect of the present disclosure, the C—C double bond-containing sultone is one or more selected from a group consisting of compounds represented by formula 1, in formula 1, R is one selected from a group consisting of C3˜C6 alkenylene group substituted or unsubstituted with one or more substituent group selected from a group consisting of C1˜C6 alkyl group, F, Cl, Br and I.

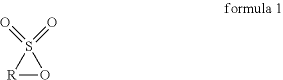

In the positive electrode plate according to the first aspect of the present disclosure, specifically, the C—C double bond-containing sultone is one or more selected from a group consisting of following compounds:

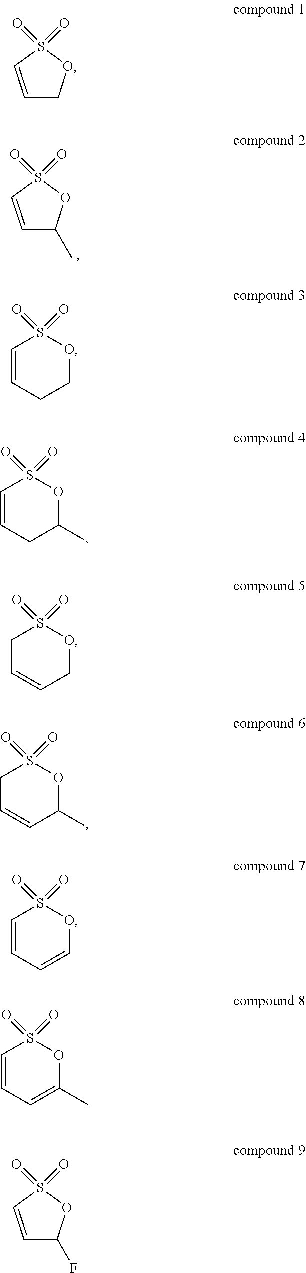

In the positive electrode plate according to the first aspect of the present disclosure, a content of the C—C double bond-containing sultone is 0.1%˜5% of a total mass of the positive electrode film. When the content of the C—C double bond-containing sultone is within this range, on the one hand, it can effectively improve anti-oxidation capability of the positive electrode plate, so as to make the positive electrode plate have good interface stability performance, thereby significantly improving high temperature storage performance of the energy storage device; on the other hand, the additive (namely the C—C double bond-containing sultone) cured in the positive electrode plate will not significantly dissolve out and enter into the electrolyte, that is, the C—C double bond-containing sultone will not diffuse into the negative electrode plate, thereby avoiding the risk of increasing interface resistance of the negative electrode plate significantly, so as to ensure that the energy storage device has good low temperature direct current internal resistance and low temperature lithium precipitation performance. If the content of the C—C double bond-containing sultone is too low, the effect of improving anti-oxidation capability of the positive electrode plate will not be attained, and if the content is too high, the additive (namely the C—C double bond-containing sultone) will dissolve out, which has a risk of increasing interface resistance of the negative electrode plate and then deteriorating power performance of the energy storage device. Preferably, the content of the C—C double bond-containing sultone is 0.1%˜2% of the total mass of the positive electrode film, further preferably, the content of the C—C double bond-containing sultone is 0.1%˜1% of the total mass of the positive electrode film.

In the positive electrode plate according to the first aspect of the present disclosure, the type of the positive current collector is not specifically limited and may be selected as desired. Specifically, the positive current collector is one selected from a group consisting of metal foil, preferably, the positive current collector is one selected from a group consisting of silver foil, copper foil, aluminum foil, further preferably, the positive current collector is selected from aluminum foil.

In the positive electrode plate according to the first aspect of the present disclosure, the thickness of the positive current collector is not specifically limited and may be selected as desired, preferably, a thickness of the positive current collector is 5 μm˜30 μm, further preferably, the thickness of the positive current collector is 8 μm˜25 μm, more preferably, the thickness of the positive current collector is 12 μm˜20 μm, even more preferably, the thickness of the positive current collector is 14 μm.

In the positive electrode plate according to the first aspect of the present disclosure, the positive electrode active material is not specifically limited and may be selected as desired. Specifically, the positive electrode active material is one or more selected from a group consisting of lithium transition metal oxide, the lithium transition metal oxide is one or more selected from a group consisting of LiCoO₂, LiMnO₂, LiNiO₂, Li₂MnO₄, LiNiₓCo_{y}Mn_{1-x-y}O₂, LiNiₓCo_{y}Al_{1-x-y}O₂ and LiNiₓMn₂₋ₓO₄, where, 0<x<1, 0<y<1, 0<x+y<1, preferably, the lithium transition metal oxide is one or more selected from a group consisting of LiCoO₂, LiNi_{1/3}Co_{1/3}Mn_{1/3}O₂, LiNi_{0.5}Co_{0.2}Mn_{0.3}O₂, LiNi_{0.6}Co_{0.2}Mn_{0.2}O₂, LiNi_{0.8}Co_{0.1}Mn_{0.1}O₂, LiNi_{0.8}Co_{0.15}Mn_{0.05}O₂, LiNi_{0.8}Co_{0.15}Al_{0.05}O₂, LiNi_{0.5}Mn_{1.5}O₄, LiNiO₂, LiMnO₂ and Li₂MnO₄, further preferably, the lithium transition metal oxide is selected from LiNi_{0.8}Co_{0.1}Mn_{0.1}O₂.

In the positive electrode plate according to the first aspect of the present disclosure, the positive electrode film further comprises a conductive agent and a binder.

In the positive electrode plate according to the first aspect of the present disclosure, when the positive electrode film comprises the conductive agent, the conductive agent is one or more selected from a group consisting of conductive carbon black, superconductive carbon black, conductive graphite, carbon fiber formed by chemical vapor deposition, acetylene black, carbon nanotube and graphene, preferably, the conductive agent is one or more selected from a group consisting of superconductive carbon black, conductive graphite, acetylene black and carbon nanotube, further preferably, the conductive agent is selected from superconductive carbon black.

In the positive electrode plate according to the first aspect of the present disclosure, when the positive electrode film comprises the conductive agent, a content of the conductive agent is 0.5%˜3% of the total mass of the positive electrode film. If the content of the conductive agent is too low, good conductive effect cannot be attained; if the content of the conductive agent is too high, the mass of the positive electrode active material of the energy storage device will be decreased, which is not beneficial for improving the energy density of the energy storage device, preferably, the content of the conductive agent is 1%˜2% of the total mass of the positive electrode film.

In the positive electrode plate according to the first aspect of the present disclosure, when the positive electrode film comprises the binder, the binder is one or more selected from a group consisting of poly(vinyl alcohol) binder, polyurethane binder, polyacrylate binder, polyvinylidene fluoride binder, styrene-butadiene rubber binder, epoxy resin binder, vinyl acetate resin binder and chlorinated rubber binder, preferably, the binder is selected from polyvinylidene fluoride binder.

In the positive electrode plate according to the first aspect of the present disclosure, when the positive electrode film comprises the binder, a content of the binder is not more than 5% of the total mass of the positive electrode film. If the content of the binder is too low, good adhesive effect cannot be attained; if the content of the binder is too high, on the one hand, the mass of the positive electrode active material of the energy storage device will be decreased, which is not beneficial for improving energy density of the energy storage device, on the other hand, ionic conductivity of the positive electrode plate will be decreased, so as to increase polarization of the charge-discharge cycle process of the energy storage device, thereby deteriorating electrical performance of the energy storage device, preferably, the content of the binder is 1%˜2% of the total mass of the positive electrode film.

In the positive electrode plate according to the first aspect of the present disclosure, in addition to the C—C double bond-containing sultone, the positive electrode film can further comprises other additive, the type of other additive is not specifically limited and may be selected as desired.

Secondly, a preparation method of a positive electrode plate according to a second aspect of the present disclosure, for preparing the positive electrode plate of the first aspect of the present disclosure, is described, and comprises steps: (1) firstly, uniformly mixing a positive electrode active material, an optional conductive agent and an optional binder, and adding a solvent for dispersing, then adding a C—C double bond-containing sultone as an additive for further mixing and dispersing, thereby obtaining the positive electrode slurry; (2) coating the positive electrode slurry obtained in the step (1) on a surface of a positive current collector, then drying, so as to form a positive electrode film; (3) rolling, slitting and slicing of the positive current collector and the positive electrode film obtained in the step (3), and obtaining the positive electrode plate.

The preparation method of the positive electrode plate of the present disclosure is simple in process, easy to operate, and suitable for large scale production.

In the preparation method of the positive electrode plate according to the second aspect of the present disclosure, in the step (1), in the mixing and dispersing of the C—C double bond-containing sultone, the temperature is not specifically limited, room temperature or heating can be selected as desired.

In the preparation method of the positive electrode plate according to the second aspect of the present disclosure, in the step (1), the type of the solvent is not specific limited, as long as the C—C double bond-containing sultone can be dispersed. Preferably, the solvent is an organic solvent, especially, the organic solvent may be one or more selected from a group consisting of heterocyclic compounds, specifically, the organic solvent may be one or more selected from a group consisting of tetrahydrofuran, pyridine, 1-methyl-2-pyrrolidinone and pyrrole, most preferably, the organic solvent is 1-methyl-2-pyrrolidinone. An amount of the solvent is not specifically limited and may be selected as desired.

In the preparation method of the positive electrode plate according to the second aspect of the present disclosure, in the step (2), the positive electrode slurry is coated on one surface or two surfaces of the positive current collector, preferably, the positive electrode slurry is coated on two surfaces of the positive current collector.

In the preparation method of the positive electrode plate according to the second aspect of the present disclosure, in the step (2), after the positive electrode slurry is coated, heating and blowing air drying is used, drying temperature is 80° C.˜110° C., if the drying temperature is too high, the C—C double bond-containing sultone is easily volatilized, the effect of improving the performance of the energy storage device cannot be achieved, and if the drying temperature is too low, the time of the drying is too long to benefit requirements of energy conservation, preferably, the drying temperature is 90° C.

In the preparation method of the positive electrode plate according to the second aspect of the present disclosure, in the step (2), an amount of the positive electrode slurry coated on the surface of the positive current collector is not specifically limited, as long as the positive electrode film formed by the positive electrode slurry can cover the surface of the positive current collector. The method of coating may be selected as desired.

In the preparation method of the positive electrode plate according to the second aspect of the present disclosure, in a preferred embodiment, a thickness of the positive electrode film coated on the surface of the positive current collector is 10 μm˜70 μm, further preferably, the thickness of the positive electrode film coated on the surface of the positive current collector is 30 μm˜60 μm, more preferably, the thickness of the positive electrode film coated on the surface of the positive current collector is 40 μm˜50 μm.

In the preparation method of the positive electrode plate according to the second aspect of the present disclosure, in the step (3), the positive electrode film and the positive current collector are cut and sliced as desired so as to obtain the positive electrode plate having a required size.

Next, an energy storage device according to a third aspect of the present disclosure is described.

The energy storage device according to the third aspect of the present disclosure comprises the positive electrode plate according to the first aspect of the present disclosure.

In the energy storage device according to the third aspect of the present disclosure, the energy storage device further comprises a negative electrode plate, a separator and an electrolyte.

In the energy storage device according to the third aspect of the present disclosure, it should be noted that, the energy storage device may be a supercapacitor, a lithium-ion battery, a lithium metal battery, a sodium-ion battery. In examples of the present disclosure, the described energy storage device is the lithium-ion battery, but the present disclosure is not limited to that.

In the lithium-ion battery, the negative electrode plate comprises a negative electrode current collector and a negative electrode film provided on the negative electrode current collector, the negative electrode film comprises a negative electrode active material. The negative electrode current collector is a copper foil.

In the lithium-ion battery, the negative electrode active material is selected from artificial graphite or natural graphite. A negative electrode conductive agent is one or more selected from a group consisting of acetylene black, conductive carbon black (Super P, Super S, 350G), carbon fibre (VGCF), carbon nanotube (CNT) and ketjenblack.

In the lithium-ion battery, the electrolyte is liquid electrolyte, the electrolyte may comprise a lithium salt and an organic solvent.

In the lithium-ion battery, the specific type of the lithium salt is not limited. Specifically, the lithium salt may be one or more selected from a group consisting of LiPF₆, LiBF₄, LiN(SO₂F)₂ (abbreviated as LiFSI), LiN(CF₃SO₂)₂ (abbreviated as LiTFSI), LiClO₄, LiAsF₆, LiB(C₂O₄)₂ (abbreviated as LiBOB) and LiBF₂C₂O₄ (abbreviated as LiDFOB).

In the lithium-ion battery, the specific type of the organic solvent is not specifically limited and may be selected as desired. Preferably, the organic solvent is non-aqueous organic solvent. The non-aqueous organic solvent may comprise any type of carbonate ester and/or carboxylate ester. The carbonate ester may comprise cyclic carbonate ester or chain carbonate ester. The non-aqueous organic solvent may further comprise halogenated carbonate ester. Specifically, the organic solvent is one or more selected from a group consisting of ethylene carbonate (EC), propylene carbonate (PC), butylene carbonate, pentylene carbonate, fluoroethylene carbonate, dimethyl carbonate, diethyl carbonate (DEC), dipropyl carbonate, ethyl methyl carbonate, γ-butyrolactone, methyl formate, ethyl formate, ethyl propionate, propyl propionate and tetrahydrofuran.

Hereinafter the present disclosure will be described in detail in combination with examples. It should be noted that, the examples described in the present disclosure are only used for explaining the present disclosure, and are not intended to limit the scope of the present disclosure. In the examples, the described energy storage device is a lithium-ion secondary battery, but the present disclosure is not limited to that.

In the following example, reagents, materials and instruments used are commercially available unless otherwise specified.

### Example 1

(1) Preparation of a positive electrode plate: LiNi_{0.8}Co_{0.1}Mn_{0.1}O₂ (NCM811, positive electrode active material), Super P (conductive agent) and polyvinylidene fluoride (PVDF, binder) were uniformly mixed, then 1-methyl-2-pyrrolidinone (NMP, solvent) was added into to make each components uniformly dispersed, after that, compound 1 as the additive was added for further mixing and dispersing, then a positive electrode slurry was obtained, where, a solid content of the positive electrode slurry was 77 wt %, a mass ratio of the positive electrode active material, the additive, the conductive agent and the binder were 96.9:0.1:2:1; the obtained positive electrode slurry was coated on two surfaces of an aluminum foil (positive current collector) with a thickness of 14 μm; blowing air drying was then performed at 90° C., after rolling, slitting and slicing, a positive electrode plate was obtained.

(2) Preparation of a negative electrode plate: graphite (negative electrode active material), Super P (conductive agent), carboxymethyl cellulose sodium (CMC, thickener) and styrene-butadiene rubber emulsion (SBR, binder) according to a mass ratio of 96.4:1.5:0.5:1.6 were mixed, then were added in deionized water (solvent), the negative electrode slurry was obtained with an action of vacuum mixer, where, a solid content of the negative electrode slurry was 54 wt %; after that the negative electrode slurry was uniformly coated on a copper foil (negative electrode current collector) with a thickness of 8 μm, and drying was then performed at 85° C., after cold rolling, edge-trimming, slicing, slitting, finally drying at 120° C. under vacuum for 12 h, a negative electrode plate was obtained.

(3) Preparation of an electrolyte: in an argon atmosphere glove box in which the water content was less than 10 ppm, EC, EMC and DEC according to a mass ratio of EC:EMC:DEC=30:50:20 were mixed as an organic solvent, then fully dried lithium salt LiPF₆ was dissolved into the mixed organic solvent, after uniformly mixed, an electrolyte was obtained. Where, a molar concentration of LiPF₆ was 1 mol/L.

(4) Preparation of a separator: a polyethylene film (PE) with a thickness of 14 μm was used as a separator.

(5) Preparation of a lithium-ion battery: the positive electrode plate, the separator, the negative electrode plate were laminated in order to make the separator separate the positive electrode plate from the negative electrode plate, then were wound to form a square electrode assembly, the square electrode assembly was welded with a tab and placed in a package film (aluminum-plastic film), then drying was performed at 80° C. to remove water, and the prepared electrolyte was injected into the dried electrode assembly and sealed, after standing-by, hot-cold pressing, forming (which was taken by charging to 3.3 V at a constant current of 0.02 C, then discharging to 3.6 V at a constant current of 0.1 C), shaping, capacity testing, the soft package lithium-ion battery with a thickness of 4.0 mm, a width of 60 mm and a length of 140 mm was obtained.

### Example 2

The preparation was the same as example 1, except that in the preparation of a positive electrode plate (step (1)), a mass ratio of the positive electrode active material, the additive, the conductive agent and the binder was 96.8:0.2:2:1.

### Example 3

The preparation was the same as example 1, except that in the preparation of a positive electrode plate (step (1)), a mass ratio of the positive electrode active material, the additive, the conductive agent and the binder was 96.7:0.3:2:1.

### Example 4

The preparation was the same as example 1, except that in the preparation of a positive electrode plate (step (1)), a mass ratio of the positive electrode active material, the additive, the conductive agent and the binder was 96.5:0.5:2:1.

### Example 5

The preparation was the same as example 1, except that in the preparation of a positive electrode plate (step (1)), a mass ratio of the positive electrode active material, the additive, the conductive agent and the binder was 96:1:2:1.

### Example 6

The preparation was the same as example 1, except that in the preparation of a positive electrode plate (step (1)), a mass ratio of the positive electrode active material, the additive, the conductive agent and the binder was 94:3:2:1.

### Example 7

The preparation was the same as example 1, except that in the preparation of a positive electrode plate (step (1)), a mass ratio of the positive electrode active material, the additive, the conductive agent, the binder was 92:5:2:1.

### Example 8

The preparation was the same as example 4, except that in the preparation of a positive electrode plate (step (1)), compound 2 was used as the additive.

### Example 9

The preparation was the same as example 4, except that in the preparation of a positive electrode plate (step (1)), compound 3 was used as the additive.

### Example 10

The preparation was the same as example 4, except that in the preparation of a positive electrode plate (step (1)), compound 4 was used as the additive.

### Example 11

The preparation was the same as example 4, except that in the preparation of a positive electrode plate (step (1)), compound 5 was used as the additive.

### Example 12

The preparation was the same as example 4, except that in the preparation of a positive electrode plate (step (1)), compound 6 was used as the additive.

### Example 13

The preparation was the same as example 4, except that in the preparation of a positive electrode plate (step (1)), compound 9 was used as the additive.

### Example 14

The preparation was the same as example 4, except that in the preparation of a positive electrode plate (step (1)), the drying temperature was 100° C.

### Example 15

The preparation was the same as example 4, except that in the preparation of a positive electrode plate (step (1)), the drying temperature was 110° C.

### Comparative Example 1

The preparation was the same as example 1, except that in the preparation of a positive electrode plate (step (1)), no additive was added into the positive electrode plate, a mass ratio of the positive electrode active material, the conductive agent and the binder was 97:2:1.

### Comparative Example 2

The preparation was the same as example 1, except that: in the preparation of a positive electrode plate (step (1)), no additive was added into the positive electrode plate, a mass ratio of the positive electrode active material, the conductive agent and the binder was 97:2:1; in the preparation of an electrolyte (step (3)), compound 1 as an electrolyte additive was added into the electrolyte, where, a content of the compound 1 was 0.1% of the total mass of the electrolyte.

### Comparative Example 3

The preparation was the same as example 1, except that: in the preparation of a positive electrode plate (step (1)), no additive was added into the positive electrode plate, a mass ratio of the positive electrode active material, the conductive agent and the binder was 97:2:1; in the preparation of an electrolyte (step (3)), compound 1 as an electrolyte additive was added into the electrolyte, where, a content of the compound 1 was 0.3% of the total mass of the electrolyte.

### Comparative Example 4

The preparation was the same as example 1, except that: in the preparation of a positive electrode plate (step (1)), no additive was added into the positive electrode plate, a mass ratio of the positive electrode active material, the conductive agent and the binder was 97:2:1; in the preparation of an electrolyte (step (3)), compound 1 as an electrolyte additive was added into the electrolyte, where, a content of the compound 1 was 0.5% of the total mass of the electrolyte.

### Comparative Example 5

The preparation was the same as example 4, except that in the preparation of a positive electrode plate (step (1)), beta-hydroxypyruvic acid lithium salt hydrate was used as the additive.

### Comparative Example 6

The preparation was the same as example 4, except that in, the preparation of a positive electrode plate (step (1)), lithium p-toluenesulfonate was used as the additive.

### Comparative Example 7

The preparation was the same as example 4, except that in the preparation of a positive electrode plate (step (1)), drying temperature was 120° C.

### Comparative Example 8

The preparation was the same as example 1, except that in the preparation of a positive electrode plate (step (1)), a mass ratio of the positive electrode active material, the additive, the conductive agent and the binder was 96.95:0.05:2:1.

### Comparative Example 9

The preparation was the same as example 1, except that in the preparation of a positive electrode plate (step (1)), a mass ratio of the positive electrode active material, the additive, the conductive agent and the binder was 91:6:2:1.

Finally, test processes and test results of the lithium-ion secondary batteries were described.

(1) Testing of High Temperature Storage Performance of the Lithium-Ion Battery

The initial volume of the lithium-ion battery was measured by using the drainage method, the initial volume was marked as V0, then the lithium-ion battery was charged to 4.2V at a constant current of 1 C at room temperature, then the lithium-ion battery was charged to 0.05 C at a constant voltage of 4.2V, then the lithium-ion battery was stored for 10 days under 85° C. in the thermostat, and every other day the lithium-ion battery was taken out to measure the volume of lithium-ion battery, the volume was marked as Vn, n was the storage days of the lithium-ion battery under 85° C., the volume expansion rate of the lithium-ion battery was calculated.

Volume expansion rate of the lithium-ion battery after stored for n days under high temperature=(Vn−V0)/V0×100%.

(2) Testing of Low Temperature Direct Current Resistance (DCR) of the Lithium-Ion Battery

The state of charge (SOC) of the lithium-ion battery was adjusted to 20% of the capacity at room temperature, then the lithium-ion battery was put in high-low temperature test chamber with a temperature of −25° C. and standby was performed for 2 h, so as to make the temperature of the lithium-ion battery reach to −25° C., then the voltage of the lithium-ion battery at this time was measured and the voltage was marked as U1, next the lithium-ion battery was discharged for 10 secs at 0.3 C, the voltage of the lithium-ion battery after discharged was measured and was marked as U2.

DCR of the lithium-ion battery=(U1−U2)/I.

(3) Testing of Low Temperature Precipitate Lithium Performance of the Lithium-Ion Battery

At −10° C., the lithium-ion battery was performed for standby for 30 mins, then was charged to a voltage of 4.2V at a constant current of 1 C, further was charged to 0.05 C at the constant voltage of 4.2V, then was performed for standby for 5 mins, and was discharged to voltage of 2.8V at a constant current of 1 C, this was a charge-discharge cycle, then the cycle process was repeated for 10 times, and then the lithium-ion battery was charged to voltage of 4.2V at a constant current of 1 C. In a desiccation room environment, the lithium-ion battery charged to 4.2V was disassembled, and the precipitate lithium on the surface of the negative electrode plate was observed. Where, the degree of the lithium precipitation was graded into no lithium precipitation, slight lithium precipitation and serious lithium precipitation. The slight lithium precipitation indicated that the area of the lithium precipitation on the surface of the negative electrode was one-tenth or less of the entire area of the surface of the negative electrode plate, serious lithium precipitation indicated that the area of the lithium precipitation on the surface of the negative electrode plate was one-third or more of the entire area of the surface of the negative electrode plate.

(4) Testing of High Temperature Thermal Stability Performance of the Lithium-Ion Battery

At 25° C., the lithium-ion battery after taking 500 times of the above charge-discharge cycle was charged to voltage of 4.2V at a constant current of 0.5 C, further was charged to 0.05 C at a constant voltage of 4.2V, then lithium-ion battery was stored in high temperature oven for 1 h at 150° C., the state of the lithium-ion battery was observed, here five batteries in each of examples and comparative examples were observed.

TABLE 1
Parameters of example 1-15 and comparative example 1-9

| | Positive electrode slurry (ratio referred to a | | | | | |
|---|---|---|---|---|---|---|
| | total mass part of 100) | | | | | |
| | | | Conductive | | | |
| | Positive electrode | | agent | Binder | Drying | Additive in |
| | active material | Additive | Super P | PVDF | temperature | Electrolyte |
| Example 1 | NCM811 with a | Compound 1 with a | With a | With a | 90° C. | / |
| | part of 96.9 | part of 0.1 | part of 2 | part of 1 | | |
| Example 2 | NCM811 with a | Compound 1 with a | With a | With a | 90° C. | / |
| | part of 96.8 | part of 0.2 | part of 2 | part of 1 | | |
| Example 3 | NCM811 with a | Compound 1 with a | With a | With a | 90° C. | / |
| | part of 96.7 | part of 0.3 | part of 2 | part of 1 | | |
| Example 4 | NCM811 with a | Compound 1 with a | With a | With a | 90° C. | / |
| | part of 96.5 | part of 0.5 | part of 2 | part of 1 | | |
| Example 5 | NCM811 with a | Compound 1 with a | With a | With a | 90° C. | / |
| | part of 96 | part of 1 | part of 2 | part of 1 | | |
| Example 6 | NCM811 with a | Compound 1 with a | With a | With a | 90° C. | / |
| | part of 94 | part of 3 | part of 2 | part of 1 | | |
| Example 7 | NCM811 with a | Compound 1 with a | With a | With a | 90° C. | / |
| | part of 92 | part of 5 | part of 2 | part of 1 | | |
| Example 8 | NCM811 with a | Compound 2 with a | With a | With a | 90° C. | / |
| | part of 96.5 | part of 0.5 | part of 2 | part of 1 | | |
| Example 9 | NCM811 with a | Compound 3 with a | With a | With a | 90° C. | / |
| | part of 96.5 | part of 0.5 | part of 2 | part of 1 | | |
| Example | NCM811 with a | Compound 4 with a | With a | With a | 90° C. | / |
| 10 | part of 96.5 | part of 0.5 | part of 2 | part of 1 | | |
| Example | NCM811 with a | Compound 5 with a | With a | With a | 90° C. | / |
| 11 | part of 96.5 | part of 0.5 | part of 2 | part of 1 | | |
| Example | NCM811 with a | Compound 6 with a | With a | With a | 90° C. | / |
| 12 | part of 96.5 | part of 0.5 | part of 2 | part of 1 | | |
| Example | NCM811 with a | Compound 9 with a | With a | With a | 90° C. | / |
| 13 | part of 96.5 | part of 0.5 | part of 2 | part of 1 | | |
| Example | NCM811 with a | Compound 1 with a | With a | With a | 100° C. | / |
| 14 | part of 96.5 | part of 0.5 | part of 2 | part of 1 | | |
| Example | NCM811 with a | Compound 1 with a | with a part | With a | 110° C. | / |
| 15 | part of 96.5 | part of 0.5 | of 2 | part of 1 | | |
| Comparative | NCM811 with a | / | With a | With a | 90° C. | / |
| example 1 | part of 97 | | part of 2 | part of 1 | | |
| Comparative | NCM811 with a | / | With a | With a | 90° C. | Compound |
| example 2 | part of 97 | | part of 2 | part of 1 | | 1 with |
| | | | | | | 0.1% |
| Comparative | NCM811 with a | / | With a | With a | 90° C. | Compound |
| example 3 | part of 97 | | part of 2 | part of 1 | | 1 with |
| | | | | | | 0.3% |
| Comparative | NCM811 with a | / | With a | With a | 90° C. | Compound |
| example 4 | part of 97 | | part of 2 | part of 1 | | 1 0.5% |
| Comparative | NCM811 with a | Beta-hydroxypyruvic | With a | With a | 90° C. | / |
| example 5 | part of 96.5 | acid lithium salt | part of 2 | part of 1 | | |
| | | hydrate with a part of | | | | |
| | | 0.5 | | | | |
| Comparative | NCM811 with a | Lithium p- | With a | With a | 90° C. | / |
| example 6 | part of 96.5 | toluenesulfonate with | part of 2 | part of 1 | | |
| | | part of 0.5 | | | | |
| Comparative | NCM811 with a | Compound 1 with a | With a | With a | 120° C. | / |
| example 7 | part of 96.5 | part of 0.5 | part of | part of 1 | | |
| Comparative | NCM811 with a | Compound 1 with a | With a | With a | 90° C. | / |
| example 8 | part of 96.95 | part of 0.05 | part of 2 | part of 1 | | |
| Comparative | NCM811 with a | Compound 1 with a | With a | With a | 90° C. | / |
| example 9 | part of 91 | part of 6 | part of 2 | part of 1 | | |

TABLE 2
Test results of example 1-15 and comparative example 1-9

| | Volume | | | |
|---|---|---|---|---|
| | expansion rate | | | |
| | after being | | | |
| | stored for 10 | DCR | Lithium precipitation | Hotbox test |
| | day under 85° C. | (mohm) of −25° C. | of −10° C. | under 150° C. |
| Example 1 | 55.60% | 295.6 | No lithium | 4 batteries were |
| | | | precipitation | on fire, 1 battery |
| | | | | were not on fire |
| Example 2 | 40.30% | 306.7 | No lithium | 3 batteries were |
| | | | precipitation | not on fire, 2 |
| | | | | batteries were |
| | | | | on fire |
| Example 3 | 34.50% | 305.4 | No lithium | 3 batteries were |
| | | | precipitation | not on fire, 2 |
| | | | | batteries were |
| | | | | on fire |
| Example 4 | 24.30% | 304.3 | No lithium | 5 batteries were |
| | | | precipitation | not on fire |
| Example 5 | 21.60% | 309.5 | No lithium | 5 batteries were |
| | | | precipitation | not on fire |
| Example 6 | 20.50% | 337.9 | Slight lithium | 5 batteries were |
| | | | precipitation | not on fire |
| Example 7 | 15.30% | 346.4 | Slight lithium | 5 batteries were |
| | | | precipitation | not on fire |
| Example 8 | 24.50% | 305.4 | No lithium | 5 batteries were |
| | | | precipitation | not on fire |
| Example 9 | 22.40% | 300.6 | No lithium | 5 batteries were |
| | | | precipitation | not on fire |
| Example 10 | 25.60% | 307.5 | No lithium | 5 batteries were |
| | | | precipitation | not on fire |
| Example 11 | 20.10% | 301.4 | No lithium | 5 batteries were |
| | | | precipitation | not on fire |
| Example 12 | 24.30% | 312.4 | No lithium | 5 batteries were |
| | | | precipitation | not on fire |
| Example 13 | 25.2% | 303.5 | No lithium | 5 batteries were |
| | | | precipitation | not on fire |
| Example 14 | 27.90% | 309.5 | No lithium | 5 batteries were |
| | | | precipitation | not on fire |
| Example 15 | 23 .40% | 308.1 | No lithium | 5 batteries were |
| | | | precipitation | not on fire |
| Comparative | 70.50% | 292.5 | No lithium | 5 batteries were |
| example 1 | | | precipitation | not on fire |
| Comparative | 52.70% | 334.7 | Slight lithium | 5 batteries were |
| example 2 | | | precipitation | not on fire |
| Comparative | 35.60% | 385.4 | Serious lithium | 3 batteries were |
| example 3 | | | precipitation | not on fire, 2 |
| | | | | batteries was on |
| | | | | fire |
| Comparative | 23.10% | 425.6 | Serious lithium | 5 batteries were |
| example 4 | | | precipitation | not on fire |
| Comparative | 100.40% | 300.4 | No lithium | 5 batteries were |
| example 5 | | | precipitation | on fire |
| Comparative | 95.60% | 312.5 | No lithium | 5 batteries was |
| example 6 | | | precipitation | on fire |
| Comparative | 70.90% | 301.0 | No lithium | 1 battery were |
| example 7 | | | precipitation | not on fire, 4 |
| | | | | batteries were |
| | | | | on fire |
| Comparative | 68.40% | 293.8 | No lithium | 5 batteries were |
| example 8 | | | precipitation | on fire |
| Comparative | 13.90% | 506.5 | Serious lithium | 5 batteries were |
| example 9 | | | precipitation | not on fire |

TABLE 3
Test results of ICP-OES of examples 4, 14-15 and
comparative examples 1, 7

| | | | Content |
|---|---|---|---|
| | | | of compound |
| | Drying | Content of S | 1 of the positive |
| | temperature | (sulphur) | electrode film |
| Comparative example 1 | 90° C. | 0.02% | / |
| Example 4 | 90° C. | 0.14% | 0.46% |
| Example 14 | 100° C. | 0.14% | 0.44% |
| Example 15 | 110° C. | 0.14% | 0.45% |
| Comparative example 7 | 120° C. | 0.03% | 0.04% |

It could be seen from comparative examples 1˜4 in combination with Table 1 and Table 2, when compound 1 was added into the electrolyte, the gas generation amount under 85° C. of the lithium-ion battery could be significantly decreased, and the high temperature thermal stability performance of the lithium-ion battery was also improved, however the low temperature direct current internal resistance of the lithium-ion battery was obviously increased, and the low temperature lithium precipitation was significantly deteriorated. It could be seen from examples 1˜15 and comparative examples 1˜4, when the C—C double bond-containing sultone was added into the positive electrode film as the additive, the low temperature direct current internal resistance of the lithium-ion battery was obviously decreased, and the low temperature precipitate lithium of the lithium-ion battery was obviously improved.

It could be seen from example 4 and comparative examples 1, 5˜6, when the beta-hydroxypyruvic acid lithium salt hydrate or the lithium p-toluenesulfonate was added into the positive electrode slurry as the additive, they did not achieve the objects of improving the high temperature storage performance and high temperature thermal stability performance of the lithium-ion battery. The possible reason was that the oxidizing polymerization reaction of the beta-hydroxypyruvic acid lithium salt hydrate or the lithium p-toluenesulfonate on the surface of the positive electrode plate could not effectively occur, therefore the anti-oxidation capability and the interface stability performance of the positive electrode plate could not be improved.

It could be seen from examples 1˜7 and comparative examples 8˜9, when the content of the C—C double bond-containing sultone of the positive electrode slurry was too high, although the high temperature storage performance and the high temperature thermal stability performance of the lithium-ion battery could be obviously improved, the low temperature direct current internal resistance of the lithium-ion battery would be increased to a certain degree and the low temperature precipitate lithium would be deteriorated. The reason was that when the content was too high, the C—C double bond-containing sultone in the positive electrode film could dissolve out to the electrolyte and diffuse into the surface of the negative electrode plate to increase the interface resistance of the negative electrode plate; when the content of the C—C double bond-containing sultone of the positive electrode slurry was too low, the objects of improving the high temperature storage performance and the high temperature thermal stability performance of the lithium-ion battery could not be achieved.

It could be seen from comparison among examples 4, 14˜15 and comparative example 7 of Table 3, when the drying temperature of the positive electrode film was higher than 110° C., the C—C double bond-containing sultone could not improve the performance of the lithium-ion battery, the possible reason was that when the positive electrode film was dried, the C—C double bond-containing sultone of the positive electrode film would be volatilized completely. After dried, the ICP-OES (Inductively Coupled Plasma Optical Emission Spectrometer) was used to measure the content of sulphur in the positive electrode film of the positive electrode plate of examples 4, 14˜15, comparative example 1 and comparative example 7, it could be seen from the results, when the drying temperature positive electrode film was 120° C., the C—C double bond-containing sultone of the positive electrode film was almost volatilized completely, therefore the object of improving the performance of the lithium-ion battery could not be achieved.

The above descriptions are merely examples of the present disclosure and are not limited the present disclosure in any way, although the present disclosure is disclosed in terms of preferred embodiments, it is not intended to limit the present disclosure, any changes or modifications made by a person of skilled in the art using the disclosed technical without departing from the scope of the present disclosure are all equal to equivalent implementation examples and will be fallen within the scope of the appended claims of the present disclosure.

What is claimed is:

1. A positive electrode plate, comprising:
a positive current collector; and
a positive electrode film provided on the positive current collector and comprising a positive electrode active material;
the positive electrode film further comprising an additive, the additive comprising a C—C double bond-containing sultone.

2. The positive electrode plate according to claim 1, wherein the C—C double bond-containing sultone is one or more selected from a group consisting of compounds represented by formula 1; 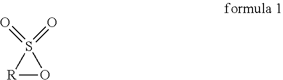
in formula 1, R is one selected from a group consisting of C3˜C6 alkenylene group substituted or unsubstituted with one or more substituent group selected from a group consisting of C1˜C6 alkyl group, F, Cl, Br and I.

3. The positive electrode plate according to claim 2, wherein the C—C double bond-containing sultone is one or more selected from a group consisting of the following compounds:

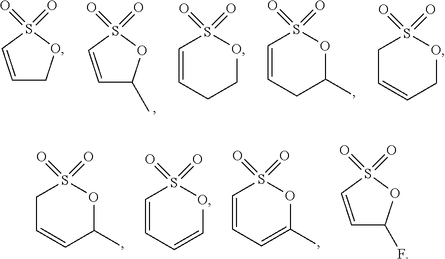

4. The positive electrode plate according to claim 1, wherein a content of the C—C double bond-containing sultone is 0.1%˜5% of a total mass of the positive electrode film.

5. The positive electrode plate according to claim 4, wherein the content of the C—C double bond-containing sultone is 0.1%˜2% of the total mass of the positive electrode film.

6. The positive electrode plate according to claim 5, wherein the content of the C—C double bond-containing sultone is 0.1%˜1% of the total mass of the positive electrode film.

7. The positive electrode plate according to claim 1, wherein the positive electrode active material is one or more selected from a group consisting of LiCoO₂, LiMnO₂, LiNiO₂, Li₂MnO₄, LiNiₓCo_{y}Mn_{1-x-y}O₂, LiNiₓCo_{y}Al_{1-x-y}O₂ and LiNiₓMn₂₋ₓO₄, where, 0<x<1, 0<y<1, 0<x+y<1.

8. The positive electrode plate according to claim 1, wherein the positive electrode film further comprises a conductive agent and a binder.

9. The positive electrode plate according to claim 8, wherein
a content of the conductive agent is 0.5%˜3% of a total mass of the positive electrode film;
a content of the binder is 5% or less of the total mass of the positive electrode film.

10. The positive electrode plate according to claim 9, wherein
the content of the conductive agent is 1%˜2% of the total mass of the positive electrode film;
the content of the binder is 1%˜2% of the total mass of the positive electrode film.

11. An energy storage device, comprising a positive electrode plate,
the positive electrode comprising a positive current collector; and
a positive electrode film provided on the positive current collector and comprising a positive electrode active material;
the positive electrode film further comprising an additive, the additive comprising a C—C double bond-containing sultone.

12. The energy storage device according to claim 11, wherein the C—C double bond-containing sultone is one or more selected from a group consisting of compounds represented by formula 1; 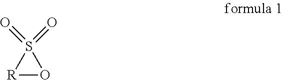
in formula 1, R is one selected from a group consisting of substituted or unsubstituted C3˜C6 alkenylene group, wherein the substituent group is one or more selected from a group consisting of C1˜C6 alkyl group, F, Cl, Br and I.

13. The energy storage device according to claim 12, wherein the C—C double bond-containing sultone is one or more selected from a group consisting of the following compounds:

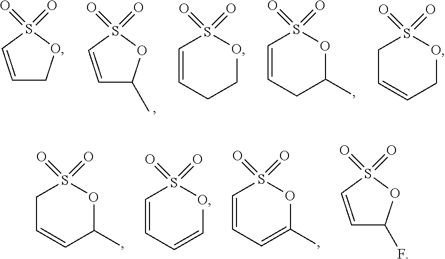

14. The energy storage device according to claim 11, wherein a content of the C—C double bond-containing sultone is 0.1%˜5% of a total mass of the positive electrode film.

15. The energy storage device according to claim 14, wherein the content of the C—C double bond-containing sultone is 0.1%˜2% of the total mass of the positive electrode film.

16. The energy storage device according to claim 15, wherein the content of the C—C double bond-containing sultone is 0.1%˜1% of the total mass of the positive electrode film.

17. The energy storage device according to claim 11, wherein the positive electrode active material is one or more selected from a group consisting of LiCoO₂, LiMnO₂, LiNiO₂, Li₂MnO₄, LiNiₓCo_{y}Mn_{1-x-y}O₂, LiNiₓCo_{y}Al_{1-x-y}O₂ and LiNiₓMn₂₋ₓO₄, where, 0<x<1, 0<y<1, 0<x+y<1.

18. The energy storage device according to claim 11, wherein the positive electrode film further comprises a conductive agent and a binder.

19. The energy storage device according to claim 18, wherein
a content of the conductive agent is 0.5%˜3% of a total mass of the positive electrode film;
a content of the binder is 5% or less of the total mass of the positive electrode film.

20. The energy storage device according to claim 19, wherein
the content of the conductive agent is 1%˜2% of the total mass of the positive electrode film;
the content of the binder is 1%˜2% of the total mass of the positive electrode film.
